(19) United States
(12) Patent Application Publication
(10) Pub. No.: US 2026/0126349 A1
(43) Pub. Date: May 7, 2026

(54) INFORMATION PROCESSING APPARATUS AND MACHINE DIFFERENCE ANALYSIS METHOD

(71) Applicant: Tokyo Electron Limited, Tokyo (JP)

(72) Inventors: Atsushi SHIGENOBU, Yamanashi (JP); Huizhen BU, Tokyo (JP); Toshiyuki FUKUMOTO, Tokyo (JP)

(21) Appl. No.: 19/370,204

(22) Filed: Oct. 27, 2025

(30) Foreign Application Priority Data
Nov. 7, 2024 (JP) 2024-194952

(51) Int. Cl. G01M 99/00

(52) U.S. Cl. CPC G01M 99/005

(57) ABSTRACT

An information processing apparatus includes an acquisition unit that acquires sensor data of a sensor that detects a state of each of a plurality of substrate processing apparatuses executing an identical process including a plurality of steps, a determination unit that determines a normalization coefficient of a summary value of the sensor data for each sensor and each step based on the sensor data for each execution of the process, a normalization processing unit that performs a normalization processing of the summary value for each sensor and each step using the normalization coefficient, an analysis unit that analyzes a machine difference of the substrate processing apparatuses based on the summary value after the normalization processing, and a display control unit that displays an analyzed result on a display.

### CROSS-REFERENCE TO RELATED APPLICATIONS

This application is based on and claims priority from Japanese Patent Application No. 2024-194952, filed on Nov. 7, 2024, with the Japan Patent Office, the disclosure of which is incorporated herein in its entirety by reference.

### TECHNICAL FIELD

The present disclosure relates to an information processing apparatus and a machine difference analysis method.

### BACKGROUND

In the related art, analysis of machine differences of substrate processing apparatuses has been performed, for example, by an expert having knowledge of the substrate processing apparatuses, who first narrows down analysis target sensors from sensors of the substrate processing apparatuses, and then checks sensor data of the analysis target sensors.

Japanese Patent Laid-Open Publication No. 2022-168572 proposes a technique in which, even when the power supplied to a heater is kept the same, a difference arises in the temperature profile due to a machine difference, which is an individual difference among apparatuses, and therefore, the target temperature used for the control of the heater is corrected to absorb the machine difference, thereby achieving uniformity of the temperature profile.

### SUMMARY

An aspect of the present disclosure is an information processing apparatus that analyzes a machine difference of a plurality of substrate processing apparatuses, including an acquisition unit that acquires sensor data of a sensor that detects a state of each of a plurality of substrate processing apparatuses executing an identical process including a plurality of steps, a determination unit that determines a normalization coefficient of a summary value of the sensor data for each sensor and each step based on the sensor data for each execution of the process, a normalization processing unit that performs a normalization processing of the summary value for each sensor and each step using the normalization coefficient, an analysis unit that analyzes the machine difference of the plurality of substrate processing apparatuses based on the summary value after the normalization processing, and a display control unit that displays an analyzed result.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram illustrating an example of a substrate processing system 1 according to the present embodiment.

FIG. 2 is a hardware configuration diagram illustrating an example of a computer.

FIG. 3 is a functional block diagram illustrating an example of a server apparatus 16 according to the present embodiment.

FIG. 4 is a flowchart illustrating an example of a machine difference analysis method according to the present embodiment.

FIGS. 5A to 5C are diagrams illustrating an example of a recipe and sensor data.

FIG. 6 is a flowchart illustrating one example of processing in step S14.

FIGS. 7A and 7B are explanatory diagrams illustrating an example of processing in step S14.

FIG. 8 is a flowchart illustrating another example of processing in step S14.

FIGS. 9A and 9B are explanatory diagrams illustrating the other example of processing in step S14.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented here.

Hereinafter, embodiments for carrying out the present disclosure will be described with reference to the drawings.

### <System Configuration>

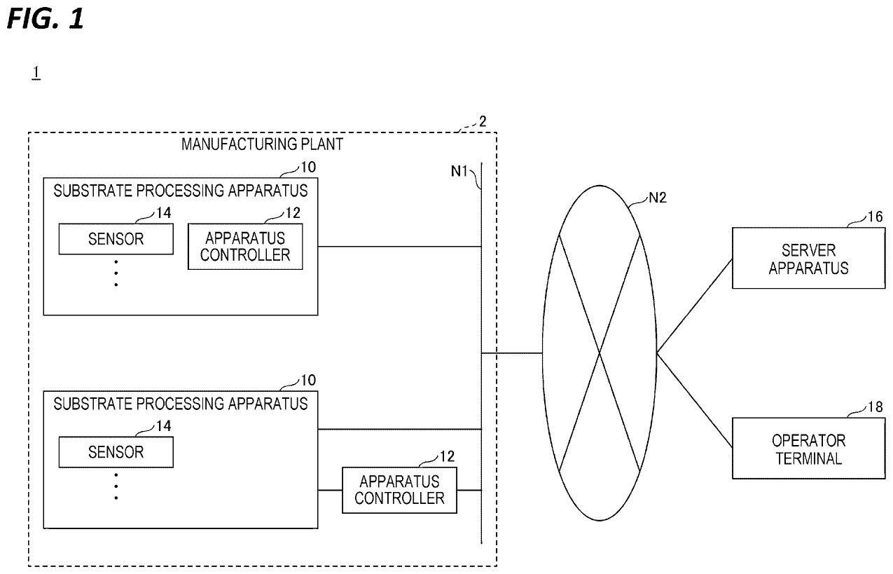

FIG. 1 is a configuration diagram illustrating an example of a substrate processing system 1 according to the present embodiment. The substrate processing system 1 illustrated in FIG. 1 includes a substrate processing apparatus 10, an apparatus controller 12, a sensor 14, a server apparatus 16, and an operator terminal 18.

The substrate processing apparatus 10, the apparatus controller 12, and the sensor 14 are installed in a manufacturing plant 2. The server apparatus 16 and the operator terminal 18 may be installed either within or outside the manufacturing plant 2. The operator terminal 18 is an information processing terminal operated by an operator such as an apparatus manager or an analysis manager of the substrate processing apparatus 10 installed in the manufacturing plant 2. The operator terminal 18 may be, for example, a personal computer (PC) or a smartphone.

The substrate processing apparatus 10, the apparatus controller 12, the sensor 14, the server apparatus 16, and the operator terminal 18 are connected in a communicable manner via networks N1 and N2 such as the Internet or a local area network (LAN).

The substrate processing apparatus 10 is an apparatus that performs a processing such as film formation, etching, or ashing, and for example, processes a substrate such as a semiconductor wafer. The substrate processing apparatus 10 may be, for example, a semiconductor manufacturing apparatus, a heat treatment apparatus, or a film forming apparatus.

The substrate processing apparatus 10 executes a process, for example, by receiving a control command according to a recipe from the apparatus controller 12. The recipe indicates the sequential steps of a process executed by the substrate processing apparatus 10. The process includes a plurality of steps. For example, the recipe is set up to divide the process into a plurality of steps (sections).

The substrate processing apparatus 10 is provided with a plurality of sensors 14. The sensors 14 detect the state of the substrate processing apparatus 10. The sensors 14 include a temperature sensor, humidity sensor, pressure sensor, vibration sensor, distance sensor, flow sensor, and others. Sensor data of the sensors 14 are time-series data. A plurality of substrate processing apparatuses 10 used for analyzing machine differences have the sensors 14 to be used as a comparison target in machine difference analysis.

The substrate processing apparatus 10 may be equipped with the apparatus controller 12, or may not be equipped with the apparatus controller 12, as long as the apparatus controller 12 is connected to the substrate processing apparatus 10 in a communicable manner. Further, the apparatus controller 12 illustrated in FIG. 1 is provided for each substrate processing apparatus 10, but may be provided for a plurality of substrate processing apparatuses 10.

The apparatus controller 12 outputs a control command for controlling control components of the substrate processing apparatus 10 according to a recipe, thereby causing the substrate processing apparatus 10 to execute a process including a plurality of steps. In addition, in the substrate processing apparatus 10, executing a process may be expressed as “RUN.” The number of times the substrate processing apparatus 10 has executed the process may be expressed as “RUN count.”

The apparatus controller 12 functions as a man-machine interface that receives instructions related to the substrate processing apparatus 10 from an operator and provides information regarding the substrate processing apparatus 10 to the operator. The apparatus controller 12 receives sensor data output from a plurality of sensors provided in the substrate processing apparatus 10. The apparatus controller 12 may store the sensor data for each process execution (hereinafter, referred to as RUN) according to a recipe.

The server apparatus 16 acquires sensor data for each RUN of a plurality of substrate processing apparatuses 10 installed in the manufacturing plant 2 from the apparatus controller 12 or the sensor 14. The server apparatus 16 determines, based on the acquired sensor data for each RUN, a normalization coefficient for the summary values of the sensor data, performs a normalization processing on the summary values of the sensor data using the normalization coefficient, and analyzes machine differences of the substrate processing apparatuses 10 based on the summary values after the normalization processing, as described later. The server apparatus 16 may display the analysis results.

The server apparatus 16 may have a function of providing a man-machine interface to an operator. Further, the server apparatus 16 may also have a function of providing a man-machine interface to an operator who operates the operator terminal 18 using a web application or a similar one. For example, the operator terminal 18 may receive and display the results analyzed by the server apparatus 16.

The apparatus controller 12 and the server apparatus 16 may cause the operator terminal 18 to display information presented to the operator. The apparatus controller 12, the server apparatus 16, and the operator terminal 18 illustrated in FIG. 1 are examples of an information processing apparatus according to the present embodiment. For example, at least a part of processing of analyzing machine differences of the substrate processing apparatuses 10 described as being performed by the server apparatus 16 may be performed by the apparatus controller 12 or the operator terminal 18.

The substrate processing system 1 illustrated in FIG. 1 is merely an example, and various system configuration examples are possible according to applications and purposes. The classification of apparatuses such as the apparatus controller 12, the server apparatus 16, and the operator terminal 18 illustrated in FIG. 1 is merely an example. For example, various configurations are possible, such as a configuration in which at least two of the apparatus controller 12, the server apparatus 16, and the operator terminal 18 are integrated, or a configuration in which they are further divided.

### <Hardware Configuration>

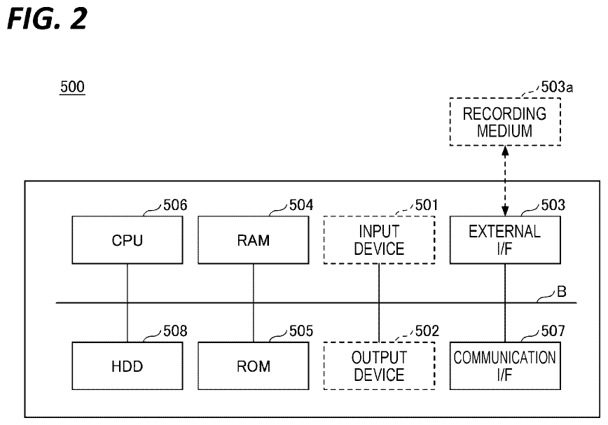

The apparatus controller 12, the server apparatus 16, and the operator terminal 18 of the substrate processing system 1 illustrated in FIG. 1 are implemented by a computer (information processing apparatus) having a hardware configuration illustrated in, for example, FIG. 2. FIG. 2 is a hardware configuration diagram illustrating an example of a computer.

The computer 500 in FIG. 2 includes various components such as an input device 501, an output device 502, an external interface (I/F) 503, a random access memory (RAM) 504, a read only memory (ROM) 505, a central processing unit (CPU) 506, a communication I/F 507, and a hard disk drive (HDD) 508, each of which is interconnected via a bus B. The input device 501 and the output device 502 may be connected and used as needed.

The input device 501 is, for example, a keyboard, a mouse, or a touch panel, and is used by an operator to input each operation signal. The output device 502 is, for example, a display that displays the processing results generated by the computer 500. The communication I/F 507 is an interface that connects the computer 500 to the network N1 or N2. The HDD 508 is an example of a non-volatile storage device that stores programs and data.

The external I/F 503 is an interface with an external device. The computer 500 may perform reading and/or writing on a recording medium 503a such as a secure digital (SD) memory card via the external I/F 503. The ROM 505 is an example of a non-volatile semiconductor memory (e.g., a storage device) in which programs and data are stored. The RAM 504 is an example of a volatile semiconductor memory (e.g., a storage device) that temporarily holds programs and data.

The CPU 506 is an operational device that implements the control and functions of the entire computer 500 by reading programs and data from storage devices such as the ROM 505 and the HDD 508 onto the RAM 504 and executing processing.

The apparatus controller 12, the server apparatus 16, and the operator terminal 18 of FIG. 1 may implement various functions to be described later by executing programs on the computer 500 having the hardware configuration illustrated in FIG. 2.

### <Functional Configuration>

In the following, an example will be described in which an information processing apparatus that analyzes machine differences of a plurality of substrate processing apparatuses 10 is the server apparatus 16. The information processing apparatus that analyzes machine differences of the plurality of substrate processing apparatuses 10 may alternatively be the apparatus controller 12 or the operator terminal 18.

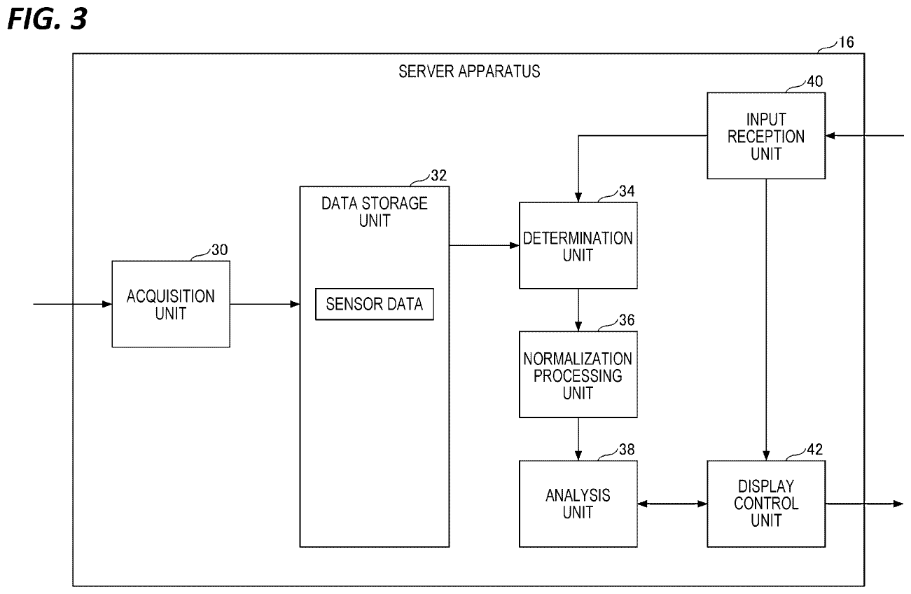

The server apparatus 16 of the substrate processing system 1 according to the present embodiment is implemented by, for example, functional blocks illustrated in FIG. 3. FIG. 3 is a functional block diagram illustrating an example of the server apparatus 16 according to the present embodiment. Components unnecessary for the description of the present embodiment are omitted in the functional block diagram of FIG. 3.

The server apparatus 16 of FIG. 3 implements an acquisition unit 30, a data storage 32, a determination unit 34, a normalization processing unit 36, an analysis unit 38, an input reception unit 40, and a display control unit 42 by executing a program for the server apparatus 16.

The acquisition unit 30 acquires sensor data of a plurality of sensors 14 that detect the state of the substrate processing apparatuses 10 executing the same process. The acquisition unit 30 may acquire the sensor data of the plurality of sensors 14 that detect the state of the substrate processing apparatuses 10 executing the same process from the substrate processing apparatus 10, from the apparatus controller 12, or from the sensors 14. The acquisition unit 30 acquires the sensor data for each RUN. The acquisition unit 30 stores the acquired sensor data for each RUN of the substrate processing apparatuses 10 in the data storage 32.

The input reception unit 40 receives various operations from an operator. For example, operations received from the operator include an application start-up operation and various operations with respect to a started application. The input reception unit 40 notifies the determination unit 34 and the display control unit 42 of the contents of various operations received from the operator.

The determination unit 34 determines, based on the sensor data for each RUN, a normalization coefficient of the summary values of the sensor data for each sensor 14 and each step, as described later. The sensor data for each sensor 14 and each step refers to sensor data for each sensor 14 divided for each step included in a process.

The summary values of the sensor data refer to statistical quantities converted from the sensor data for each sensor 14 and each step. The summary values of the sensor data include, for example, a maximum value, a minimum value, an average value, a median value, or a variance of the sensor data for each sensor 14 and each step.

The normalization coefficient of the summary values of the sensor data is used for normalization processing of the summary values of the sensor data. Normalization refers to converting units or scales of data into a common standard in order to facilitate comparison or analysis.

The normalization processing unit 36 performs a normalization processing of the summary values of the sensor data for each sensor 14 and each step using the normalization coefficient determined by the determination unit 34, as described later.

The analysis unit 38 analyzes machine differences of the plurality of substrate processing apparatuses 10 based on the summary values of the sensor data after the normalization processing by the normalization processing unit 36, as described later.

The display control unit 42 causes the output device 502 of the server apparatus 16 or the output device 502 of the operator terminal 18 to display the results analyzed by the analysis unit 38. The display control unit 42 may also cause the output device 502 of the apparatus controller 12 to display the results analyzed by the analysis unit 38.

The functional block diagram illustrated in FIG. 3 is merely an example. At least a part of the functional blocks in FIG. 3 may be provided in the computer 500 other than the server apparatus 16. At least a part of the functional blocks in FIG. 3 may also be provided, for example, in the apparatus controller 12 or the operator terminal 18.

### <Normalization Processing>

For example, the normalization processing of the sensor data may be carried out based on the resolution of the sensor data of the sensor 14. The resolution may, for example, correspond to the sensitivity of the sensor 14, and may represent the limit of fineness in measurement by the sensor 14. When the normalization processing of the sensor data is carried out based on the resolution of the sensor data of the sensor 14 and when the sensor data is A and the resolution is B, normalization processing is carried out by A×10^{B}. In addition, B is “1” when the resolution is “0.1,” and is “3” when the resolution is “0.001.”

The resolution of the sensor data of the sensor 14 and the amount of change in sensor data in a normal state may not be always correlated. Therefore, when the normalization processing of the sensor data is carried out based on the resolution of the sensor data, machine differences may be analyzed as excessively large when the resolution of the sensor data is extremely small and the amount of change in sensor data in a normal state (e.g., the amount of change within a normal range) is large. For example, in the sensor data with the resolution differing by one digit, the amount of change after normalization differs by a factor of 10.

Accordingly, in the present embodiment, in order to improve the accuracy of analyzing machine differences using the sensor data of the plurality of sensors 14 of the plurality of substrate processing apparatuses 10, improvements in the normalization processing of the sensor data are carried out as follows.

### <Processing>

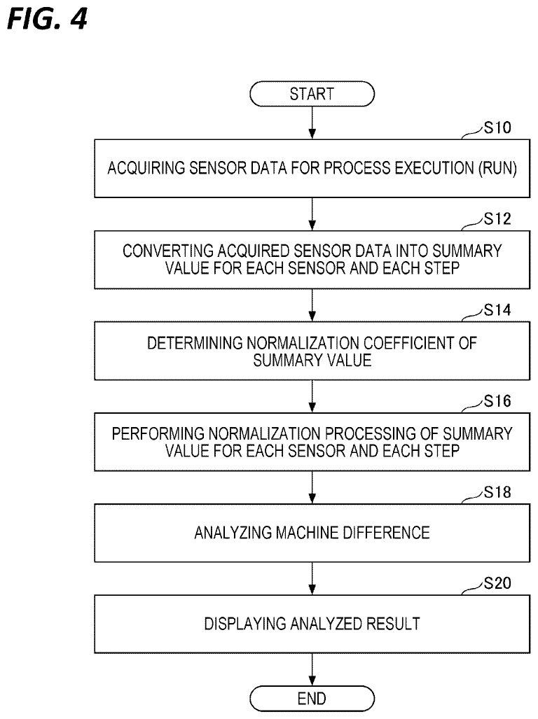

A machine difference analysis method according to the present embodiment is implemented, for example, according to the sequence illustrated in the flowchart of FIG. 4. FIG. 4 is a flowchart illustrating an example of a machine difference analysis method according to the present embodiment. Here, an example will be described in which the server apparatus 16 performs the machine difference analysis method according to the present embodiment.

In step S10, the acquisition unit 30 of the server apparatus 16 acquires sensor data for each run of the plurality of substrate processing apparatuses 10 that have executed the same process according to the sequence specified in a recipe, and stores the sensor data in the data storage 32.

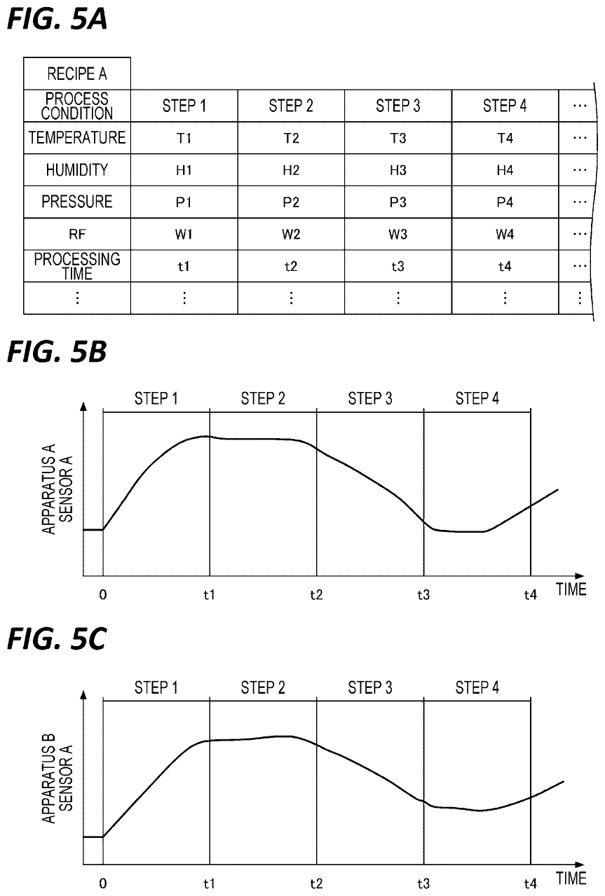

FIGS. 5A to 5C are diagrams illustrating an example of a recipe and sensor data. FIG. 5A illustrates an example of a recipe. In the recipe of FIG. 5A, the process conditions of recipe A executed by the plurality of substrate processing apparatuses 10 are illustrated for each process sequence (e.g., step). In FIG. 5A, an example of the process conditions includes temperature, humidity, pressure, RF, and processing time.

FIGS. 5B and 5C illustrate an example of sensor data. FIG. 5B illustrates an example of sensor data detected by the sensor 14 referred to as sensor A of the substrate processing apparatus 10 referred to as apparatus A during execution of recipe A by the substrate processing apparatus 10. FIG. 5C illustrates an example of sensor data detected by the sensor 14 referred to as sensor A of the substrate processing apparatus 10 referred to as apparatus B during execution of recipe A by the substrate processing apparatus 10. The sensors A in FIGS. 5B and 5C are the sensors 14 of the same type, and represent an example of the sensors 14 as comparison targets when analyzing machine differences.

The sensor data illustrated in FIGS. 5B and 5C are an example of sensor data for each process execution (RUN). The sensor data illustrated in FIGS. 5B and 5C may be divided by step, which is the period for dividing the processing time of the process condition of each step set up in recipe A illustrated in FIG. 5A.

For example, the sensor data in FIG. 5B, which is detected by sensor A of the substrate processing apparatus 10 referred to as apparatus A, may be divided into sensor data of “step 1” of recipe A, sensor data of “step 2” of recipe A, sensor data of “step 3” of recipe A, and sensor data of “step 4” of recipe A.

Further, for example, the sensor data in FIG. 5C, which is detected by sensor A of the substrate processing apparatus 10 referred to as apparatus B, may be divided into sensor data of “step 1” of recipe A, sensor data of “step 2” of recipe A, sensor data of “step 3” of recipe A, and sensor data of “step 4” of recipe A.

The sensor data of “step 1” of recipe A, the sensor data of “step 2” of recipe A, the sensor data of “step 3” of recipe A, and the sensor data of “step 4” of recipe A are examples of sensor data for each sensor 14 and each step.

In step S12, the determination unit 34 divides the sensor data for each RUN of the plurality of substrate processing apparatuses 10 into sensor data for each sensor 14 and each step. The determination unit 34 converts the sensor data for each sensor 14 and each step into the summary values. By performing the processing in step S12, the determination unit 34 calculates the summary values of the sensor data for each substrate processing apparatus 10, each RUN, each sensor 14, and each step.

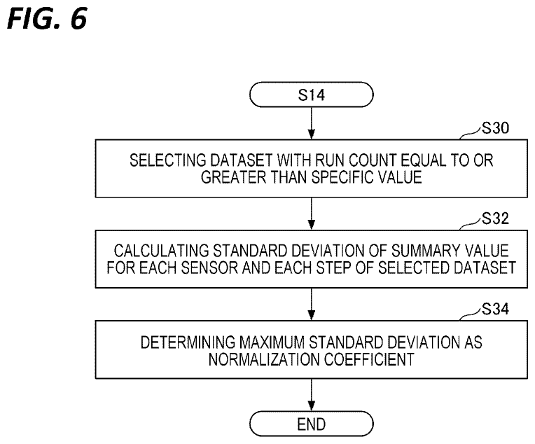

In step S14, the determination unit 34 determines a normalization coefficient of the summary values of the sensor data for each sensor 14 and each step converted in step S12. For example, the processing in step S14 may be performed in the sequence illustrated in FIG. 6.

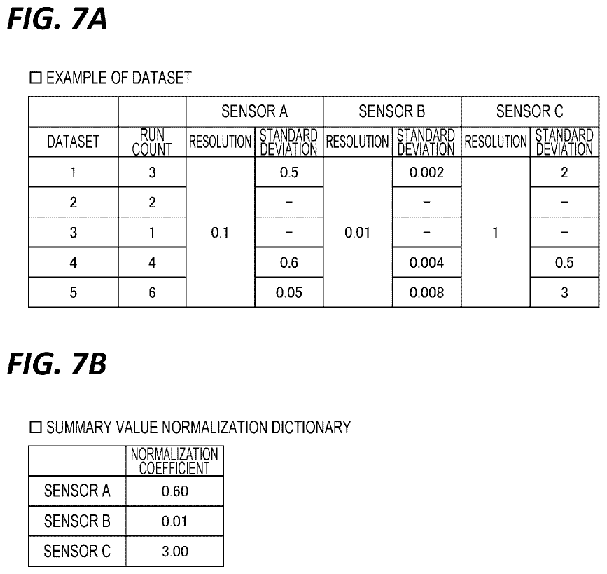

FIG. 6 is a flowchart illustrating one example of processing in step S14. FIGS. 7A and 7B are explanatory diagrams illustrating one example of processing in step S14. Five datasets in FIG. 7A are, for example, created for each of the plurality of substrate processing apparatuses 10 for analyzing machine differences. The five datasets in FIG. 7A include the summary values of the sensor data of the plurality of substrate processing apparatuses 10 executing the same step of the same process. For example, dataset “1” includes the summary values of sensor data of a certain substrate processing apparatus 10 executing a specific step of a specific process for a RUN count “3.” The five datasets in FIG. 7A are examples of a plurality of datasets.

In step S30 of FIG. 6, the determination unit 34 selects the datasets having a RUN count equal to or greater than a specific value (e.g., a specific count). The reason for selecting the datasets having a RUN count equal to or greater than the specific value is that, when the datasets include sensor data of the sensor 14 exhibiting a large RUN-to-RUN variation, there is a possibility that the summary values of the dataset having an extremely small RUN count may significantly deviate from the summary values of the other datasets. When the summary values deviate significantly, analyzed machine differences may become excessively large. The determination unit 34 selects, for example, the datasets having a RUN count of 3 or more.

For example, in FIG. 7A, datasets “1,” “4,” and “5” having a RUN count of “3” or more are selected. Datasets “2” and “3” each have a RUN count of less than “3”, and are excluded from calculation targets.

In step S32, the determination unit 34 calculates the standard deviations of the summary values of the sensor data for each sensor 14 and each step of the datasets selected in step S30. In step S32, the standard deviations of the summary values of the sensor data for each sensor 14 of the datasets selected in step S30 are calculated.

For example, in FIG. 7A, the standard deviations of the summary values of the sensor data of datasets “1,” “4,” and “5” are calculated for each sensor 14. For example, in FIG. 7A, standard deviations “0.5,” “0.6,” and “0.05” of the summary values of the sensor data of the sensor 14 referred to as “sensor A” are calculated. Further, in FIG. 7A, the resolution is set for each sensor 14. The resolution in FIG. 7A is the minimum resolution of the sensor 14.

In step S34, the determination unit 34 determines the maximum standard deviation calculated in step S32 as the normalization coefficient. For example, in FIG. 7A, among the standard deviations “0.5,” “0.6,” and “0.05” of the summary values of the sensor data of the sensor 14 referred to as “sensor A,” the maximum standard deviation “0.6” is determined as the normalization coefficient.

Further, the determination unit 34 determines the minimum resolution as the normalization coefficient if the minimum resolution is greater than the calculated maximum standard deviation. For example, in FIG. 7A, since the minimum resolution “0.01” is greater than the maximum standard deviation “0.008” of the summary values of the sensor data of the sensor 14 referred to as “sensor B,” the minimum resolution “0.01” is determined as the normalization coefficient.

The determination unit 34 determines, from the datasets in FIG. 7A, for example, the normalization coefficient for each sensor 14 as illustrated in FIG. 7B. FIG. 7B illustrates an example of a normalization dictionary for the summary values in which the determined normalization coefficient is set for each sensor 14. The processing in step S14 may also be expressed as max (e.g., the maximum standard deviation of the summary values included in the datasets having a RUN count equal to or greater than a specific value, the minimum resolution). The function “max ( )” outputs the maximum value of data within the parentheses.

Returning to step S16 of FIG. 4, the normalization processing unit 36 performs a normalization processing of the summary values for each sensor 14 and each step using the normalization coefficient determined in step S14. The normalization processing in step S16 is performed as illustrated in Equation (1):

$$Summary value after normalization = Summary value / max ( maximum standard deviation of summary values included in datasets having RUN count equal to or greater than specific value , minimum resolution ) \qquad [ Equation 1 ]$$

In Equation (1), the summary values after the normalization processing are calculated by dividing the summary values before the normalization processing by the normalization coefficient determined in step S14. The normalization processing unit 36 calculates the summary values after the normalization processing for each sensor 14 and each step by performing the normalization processing illustrated in Equation (1).

In step S18, the analysis unit 38 analyzes machine differences of the plurality of substrate processing apparatuses 10 based on the summary values after the normalization processing. For example, the analysis unit 38 performs dimensionality reduction of the data space of the summary values after the normalization processing by principal component analysis, and analyzes machine differences of the substrate processing apparatuses based on the magnitude of the distances of the summary values in the data space after the dimensionality reduction.

In the present embodiment, since small data is obtained by conversion from sensor data into summary values and dimensionality reduction after the normalization processing, analysis of machine differences targeting sensor data of all the sensors 14 is facilitated. Further, since the normalization processing is performed based on inter-RUN differences of sensor data, machine differences of the sensors 14 may be uniformly evaluated as degrees of deviation from inter-RUN differences, which ensures efficient identification of machine differences.

In step S20, the display control unit 42 displays the results of analysis in step S18 on the output device 502 of the server apparatus 16, the operator terminal 18, or the apparatus controller 12. The processing in step S20 may also be notification of the results of analysis in step S18 to the operator by e-mail or printing on paper.

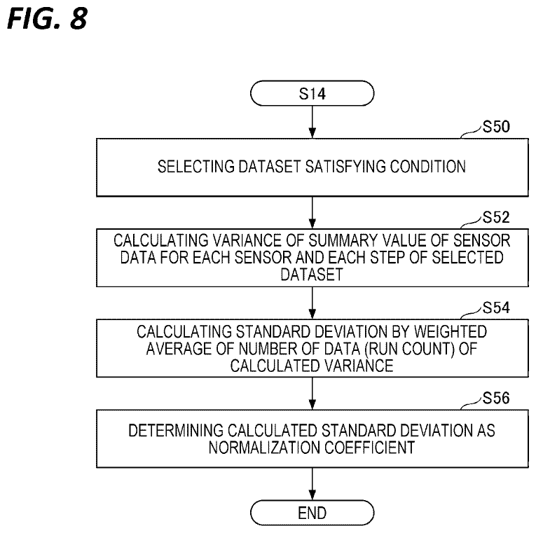

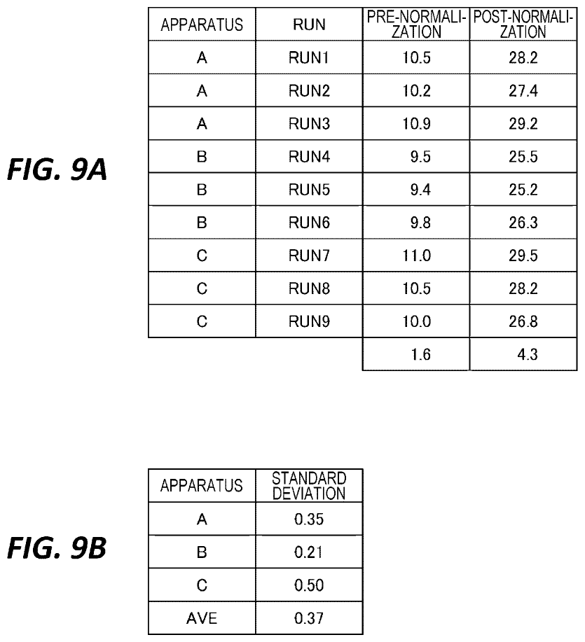

The processing in step S14 may be performed according to the sequence illustrated in FIG. 8. FIG. 8 is a flowchart illustrating another example of processing in step S14. Further, FIGS. 9A and 9B are explanatory diagrams illustrating the other example of processing in step S14.

In step S50, the determination unit 34 selects datasets satisfying a condition. The condition is, for example, a RUN count of “2” or more. In step S50, the datasets having a RUN count of “2” or more are selected, in order to perform a normalization processing based on inter-RUN differences of sensor data.

In step S52, the determination unit 34 calculates a variance (unbiased variance) of the summary values of the sensor data for each sensor 14 and each step of the datasets selected in step S50.

In step S54, the determination unit 34 calculates the standard deviation by a weighted average of the number of data (e.g., RUN count) of the calculated variance. The processing in step S54 is performed as illustrated in Equation (2):

$${σ}^{2} = \frac{1}{N} {\sum }_{k = 1}^{n} {N}_{k} * {σ}_{k}^{2} \qquad [ Equation 2 ]$$

σₖ²: unbiased variance of datasets satisfying a condition
Nₖ: the number of data in each dataset
n: the number of datasets satisfying a condition
N: the total number of data in datasets satisfying a condition
※ condition: RUN count of 2 or more

In Equation (2), the weighted average of the number of data in the variance of the summary values for each sensor 14 and each step of each dataset calculated in step S52 is used to calculate the average (AVE) of the standard deviations of the plurality of substrate processing apparatuses 10, as illustrated in FIG. 9B. In Equation (2), σₖ² represents the unbiased variance of datasets satisfying the condition. Further, Nₖ represents the number of data in each dataset. Further, n represents the number of datasets satisfying the condition. Further, N represents the total number of data in the datasets satisfying the condition.

In FIG. 9B, based on the standard deviation of “0.35” of the substrate processing apparatus 10 referred to as apparatus A, the standard deviation “0.21” of the substrate processing apparatus 10 referred to as apparatus B, and the standard deviation “0.50” of the substrate processing apparatus 10 referred to as apparatus C, the average of the standard deviations “0.37” is calculated. The average of the standard deviations is calculated after conversion to variance.

In step S56, the determination unit 34 determines the average of the standard deviations of the plurality of substrate processing apparatuses 10, calculated in step S54, as the normalization coefficient. In FIG. 9B, the average of the standard deviations “0.37” calculated in step S54 is set as the normalization coefficient.

The “pre-normalization” values in FIG. 9A are the summary values of sensor data of a specific sensor 14 during execution of a specific step, converted for each substrate processing apparatus 10 and each RUN. The “post-normalization” values in FIG. 9A are obtained by dividing the “pre-normalization” values in FIG. 9A by the normalization coefficient determined in step S56. For example, the “post-normalization” value “28.2” for “apparatus A” and “RUN 1” in FIG. 9A is obtained by dividing the pre-normalization value “10.5” by the normalization coefficient “0.37” determined in step S56. Further, the values set in the lowest cells of FIG. 9A indicate the range of the pre-normalization summary values and the range of the post-normalization summary values.

By using Equation (2) as described above, it is possible to avoid an excessive increase in the normalization coefficient even if an anomalous summary value is present in the dataset with the largest number of data.

According to the present embodiment, an expert having knowledge about the substrate processing apparatus 10 may comprehensively analyze machine differences from sensor data of all the sensors 14 of the plurality of substrate processing apparatuses 10 without narrowing down the analysis target sensors 14 among the sensors 14 of the substrate processing apparatuses 10. Further, by comprehensively analyzing machine differences from the sensor data of all the sensors 14, the possibility of the sensor 14 experiencing a state change being excluded from the analysis target may be reduced. Further, according to the present embodiment, even a person having no knowledge about the substrate processing apparatuses 10 may analyze individual differences (e.g., machine differences) of the substrate processing apparatuses 10 without going through a process of narrowing down the analysis target sensors 14.

According to the present embodiment, it is possible to improve the accuracy of analyzing machine differences using the sensor data of the plurality of sensors 14 of the plurality of substrate processing apparatuses 10. Further, according to the present embodiment, it is possible to facilitate the analysis of machine differences using the sensor data of the plurality of sensors 14 of the plurality of substrate processing apparatuses 10. The machine difference analysis method according to the present embodiment may be used, for example, to verify that there is no difference between a reference apparatus and a mass-production apparatus for the substrate processing apparatus 10, for example, to ensure that the reference apparatus and the mass-production apparatus do not operate differently. The machine difference analysis method according to the present embodiment may also be used to analyze machine differences caused by individual differences between the sensors 14, individual component differences, or assembly errors.

According to the present disclosure, it is possible to improve the accuracy of analyzing machine differences using sensor data of a plurality of sensors of a plurality of substrate processing apparatuses.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
acquisition circuitry configured to acquire sensor data of a sensor that detects a state of each of a plurality of substrate processing apparatuses executing an identical process including a plurality of steps;
determination circuitry configured to determine a normalization coefficient of a summary value of the sensor data for each sensor and each step based on the sensor data for each execution of the process;
normalization processing circuitry configured to perform a normalization processing of the summary value for each sensor and each step using the normalization coefficient;
analysis circuitry configured to analyze a machine difference of the plurality of substrate processing apparatuses based on the summary value after the normalization processing; and
display control circuitry configured to display an analyzed result on a display.

2. The information processing apparatus according to claim 1, wherein the determination circuitry calculate, from a plurality of datasets including the sensor data having a number of executions of the process equal to or greater than a specific value, a standard deviation of the summary value of the sensor data for each sensor and each step included in the datasets, select a maximum standard deviation from the calculated standard deviation, and then determine the maximum standard deviation as the normalization coefficient.

3. The information processing apparatus according to claim 2, wherein the determination circuitry determine a value greater of the maximum standard deviation or a minimum resolution, as the normalization coefficient.

4. The information processing apparatus according to claim 1, wherein the determination circuitry determine a standard deviation calculated by a weighted average of a number of executions of the process in a variance of the summary value of the sensor data for each sensor and each step included in a plurality of datasets satisfying a condition, as the normalization coefficient.

5. The information processing apparatus according to claim 1, wherein the summary value of the sensor data is a statistical quantity converted from the sensor data for each sensor and step.

6. The information processing apparatus according to claim 1, wherein the analysis circuitry perform dimensionality reduction of a data space of the summary value after the normalization processing by principal component analysis, and analyze the machine difference of the plurality of substrate processing apparatuses based on a magnitude of a distances of the summary value in the data space after the dimensionality reduction.

7. A machine difference analysis method comprising:
acquiring sensor data of a sensor that detects a state of each of a plurality of substrate processing apparatuses executing an identical process including a plurality of steps;
determining a normalization coefficient of a summary value of the sensor data for each sensor and each step based on the sensor data for each execution of the process;
performing a normalization processing of the summary value for each sensor and each step using the normalization coefficient;
analyzing a machine difference of the plurality of substrate processing apparatuses based on the summary value after the normalization processing; and
displaying an analyzed result on a display.
